(19) United States
(12) Patent Application Publication
(10) Pub. No.: US 2010/0013178 A1
(43) Pub. Date: Jan. 21, 2010

(54) HAND TRUCK FOR TRANSPORTING A PAIL

(76) Inventor: James Edward Blair, Naples, FL (US)

Correspondence Address: QUARLES & BRADY LLP, 411 E. WISCONSIN AVENUE, SUITE 2040, MILWAUKEE, WI, 53202-4497, US

(21) Appl. No.: 12/173,301

(22) Filed: Jul. 15, 2008

(51) Int. Cl. B62B 1/16

(52) U.S. Cl. 280/47.27

(57) ABSTRACT

A hand truck, for transporting a large pail, includes a frame that has a shaft with one end to which a user handle is attached and another end attached to a middle portion of a U-shaped frame section. The U-shaped frame section has two spaced-apart legs with a separate wheel mounted to each leg. A boom is attached to and projects away from the frame and has a receiver for engaging a handle of the pail. When the receiver is engaging the handle of the pail, rotating the frame about the wheels raises the pail which thereby becomes suspended from the boom. The pail, when suspended, is able to swing freely on the boom without striking the frame or the wheels.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to hand trucks for transporting items, and more particularly to hand trucks specifically adapted for transporting pails.

2. Description of the Related Art

Various types of products, such as paint and wallboard joint compound, are commonly sold in five gallon pails. The term pail, as defined and used herein, refers to a bucket, or similar container, with a handle extending above and across the bucket. Usually the handle is a generally cylindrical body through which an inverted U-shaped wire extends with the ends of the wire pivotally attached to opposite sides of the bucket. A user is able to carry the pail by grasping the handle in the palm of one hand and lifting upward, which results in the bucket being suspended from the handle. Five gallon buckets when full of material often are very heavy and when being carried, bang against the legs of the lifting person.

Large pails, containers, and other items are frequently transported using a hand truck. A common design of a hand truck has a pair of wheels located at the bottom of an upwardly extending frame. A platform, often formed by a piece of heavy gauge sheet metal, projects forward at the bottom of the frame and typically rests flat on the floor when the hand truck is stationary. The item or items being transported are placed on the platform. Then the upper end of the hand truck is tilted backwards about the wheels, thereby raising the platform and the items off the floor. In this tilted position, the truck is then rolled on the wheels to the desired location where the items are to be delivered. The frame is then tilted forward until the platform rests on the floor and the platform is removed from beneath the items.

Such hand trucks can be used to transport five gallon pails of various products. However, when the pail is relatively full, its top opening must be sealed with a cover to prevent the contents from spilling when the hand truck is tilted for movement. Though such a restriction does not present a problem when transporting previously unopened pails, it can present a problem when the pail is being reused to transport other types of materials. For example, if a pail is being reused to transport water, the cover may no longer be available and thus the pail cannot be filled to its maximum capacity without the water spilling out when the hand truck is tilted.

As a consequence, it is desirable to design a hand truck that will allow open, full pails to be transported without readily spilling the contents.

### SUMMARY OF THE INVENTION

A hand truck, for transporting a pail, includes a frame that has a main section with a user handle and that has first and second spaced apart legs extending from the main section. First and second wheels are respectively attached to the first and second legs at points remote from the main section. A boom is attached to and projects away from the frame and has a receiver for engaging a handle of the pail. When the receiver is engaging the pail handle, rotating the frame about the wheels raises the pail which becomes suspended from the boom.

With the pail so suspended, the hand truck can be wheeled around to a desired location. During movement of the hand truck, the pail can swing freely on the boom without striking the frame or the wheels. That free swinging suspension permits transportation of an open, relatively full pail without spilling its contents.

### BRIEF DESCRIPTION OF THE DRAWINGS

FIG. 1 is a front view of a hand truck that is stationary on a surface with a pail attached thereto;

FIG. 2 is a side view of the hand truck and pail in FIG. 1;

FIG. 3 is a side view of the hand truck that has been tilted in order to move the pail; and

FIG. 4 is a front view of the tilted hand truck in FIG. 3.

### DETAILED DESCRIPTION OF THE INVENTION

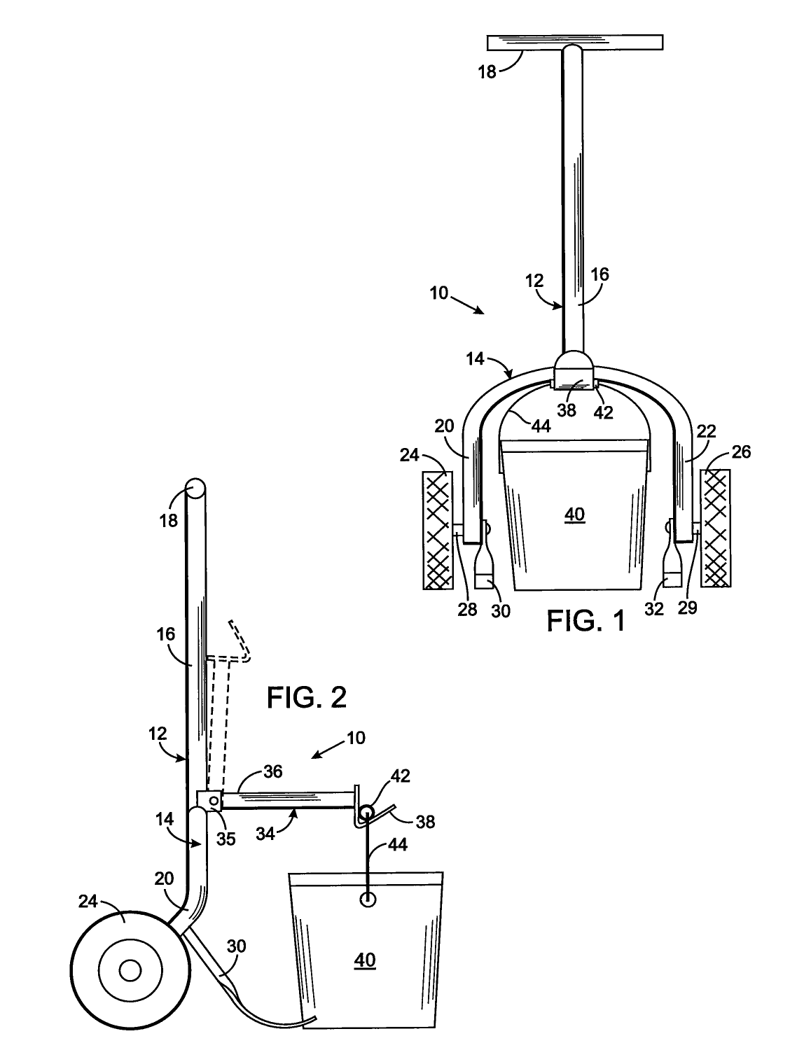

With initial reference to FIGS. 1 and 2, a hand truck 10 has a generally upright frame 12 comprising a lower inverted U-shaped section 14 from which a tubular shaft 16 extends to a cross handle 18. The bottom end of the shaft 16 is fastened to the center of the U-shaped section 14 and to the center of the handle 18 forming a T-shaped upper end of the frame 12. The U-shaped section 14 has a first leg 20 that curves downward from one side of the shaft 16 and a second leg 22 curving downward from the other side of the shaft. The shaft 16 and the handle 18 form a main section of the frame from which the legs 20 and 22 extend. The main section, and particularly the handle, may have other shaped than that disclosed in the drawings.

As shown specifically in FIG. 2, as each leg 20 and 22 projects downward, it is bowed toward the rear of the hand truck terminating at a lower end. A separate wheel 24 or 26 is attached by a different axle 28 or 29 to one of the legs 20 or 22, respectively. This attachment of the wheels 24 and 26 enables the frame to pivot backwards, i.e. counterclockwise in FIG. 2, and when so tilted, enables the hand truck 10 to be rolled along a surface, such as a floor of a building. One of a pair of feet 30 and 32 project downward from and are fastened to the lower portion of each leg 20 and 22. Each foot rests on the surface when the shaft 16 is in a vertical position. The support provided by the feet 30 and 32 enables the hand truck to stand upright on the wheels 24 and 26 unaided. The shaft 16, U-shaped section 14, and the feet 30 and 32 can be made of steel and welded together.

A carrier 34 projects forward from and is attached to the frame 12 for engaging a pail 40 to be carried. The particular embodiment of a carrier 34 shown in FIG. 2 comprises a boom 36 that extends perpendicularly forward from the frame 14. Preferably, the boom 36 is a tubular support shaft coupled to the frame 14 by a hinge 35 thereby enabling the boom to be rotated upward against the shaft 16, as shown by phantom lines, when not engaging a pail. A stop holds the boom 36 in the lowered position. Alternatively, the boom 36 may be fixed to the frame 12, such as by welding for example. A receiver 38, such as a carrying hook, is attached to the remote end of the boom 36 so as to engage the handle 42 of a pail 40 that is to be transported. The height at which the boom 36 is located above the floor, when the hand truck 10 was resting on the floor as shown in FIGS. 1 and 2, is determined by the height of the handle of the pail that is to be transported. For example, standard five gallon pails, in which a wide variety of products are packaged, have generally uniform heights, thereby enabling a fixed design of a hand truck to be utilized with most pails of that volume. The length of the boom 36 also is determined so that the pail 40 will swing freely during transport, as will be described. For a typical five gallon pail, the boom 36 may extend 12 inches from the frame 14 and the receiver may be approximately 19 inches above the floor when the hand truck is positioned as shown in FIG. 2. The height of the boom 36 may be adjustable to accommodate pails of different sizes.

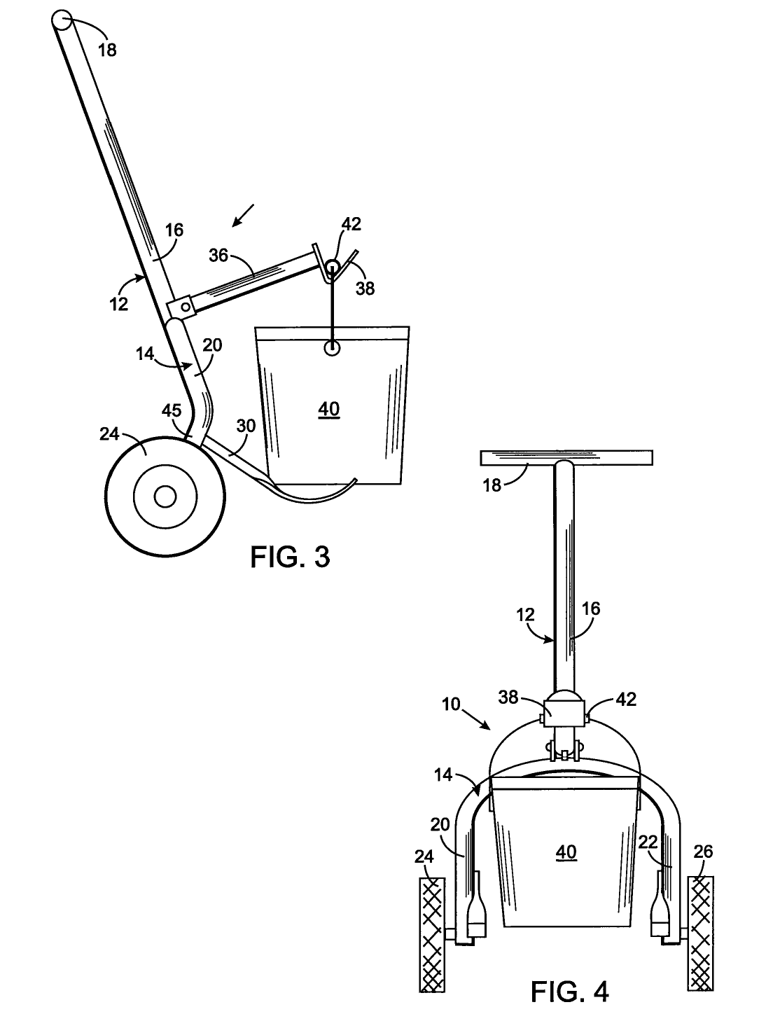

To transport the pail 40, its handle 42 is raised above the bucket and placed onto the receiver 38 of the hand truck 10. The pail may have to be lifted slightly to place the handle into a hook-type receiver or the hand truck may be tilted forward on the feet 30 to lower the hook to fit underneath the handle. In the orientation illustrated in FIG. 2, the user of the hand truck, positioned to the left side, pulls the hand truck handle 18 backwards to pivot the frame 14 counterclockwise about the wheels 24 and 26. This action raises the receiver 38 upward, lifting the pail 40 off the floor into a position as illustrated in FIG. 3. The hand truck may be tilted farther so that the lower section 45 of the leg 20 is generally vertical.

As shown in FIGS. 3 and 4, the pail 40 is raised off of floor and is suspended in front of the frame 12 so that it does not contact that frame. This allows the pail 40 to remain in a upright position by gravity, thus preventing its contents from spilling while being transported, even when the top of the pail is open. Because the legs 20 and 22 and the support feet 30 and 32 are spaced apart (see FIG. 4), the pail 40 can swing freely there between without striking the those components or other parts of the frame 12 as the hand truck 10 is moved.

After the hand truck 10 has moved the pail 40 to the desired location, the frame 12 is tilted forward to the vertical position shown in FIG. 2, which lowers the pail onto the floor. The receiver 38 then is disengaged from the pail handle 42.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

What is claimed is:

1. A hand truck for transporting a pail that has a handle, said hand truck comprising:
a frame having a main section with a user handle and having first and second legs spaced apart and extending from the main section to remote ends;
a first and second wheels attached to remote ends of the first and second legs, respectively; and
a boom attached to and projecting away from the frame and having a receiver for engaging the handle of the pail, wherein when the receiver is engaging the handle of a pail, rotating the frame about the wheels, raises the pail which becomes suspended from the boom.

2. The hand truck as recited in claim 1 wherein the first and second legs are spaced apart by a distance that enables the pail, when suspended from the boom, to swing freely between the first and second legs.

3. The hand truck as recited in claim 1 wherein the boom is pivotally attached to the frame

4. The hand truck as recited in claim 1 wherein the receiver for engaging the handle of a pail comprises a hook.

5. The hand truck as recited in claim 1 wherein the receiver for engaging the handle of a pail comprises a plate bent into a V-shape.

6. The hand truck as recited in claim 1 further comprising a foot attached to the frame for supporting the frame in a stationary state of the hand truck.

7. An hand truck for transporting a pail that has a handle, said hand truck comprising:
a frame comprising a shaft, a user handle attached adjacent one end of the shaft, and a U-shaped section having a middle portion attached to another end of the shaft and having two spaced-apart legs;
a first and second wheels each attached to a different one of the two spaced-apart legs; and
a boom attached to and projecting outwardly from the frame and having an receiver for engaging the handle of the pail, wherein when the receiver is engaging the handle of a pail, rotating the frame about the wheels, raises the pail which becomes suspended from the boom.

8. The hand truck as recited in claim 7 wherein the boom comprises a support shaft attached at a proximate end to the frame and having a remote end to which the receiver is attached.

9. The hand truck as recited in claim 8 wherein the receiver comprises a plate bent into a V-shape.

10. The hand truck as recited in claim 8 wherein the receiver for engaging the handle of a pail comprises a hook.

11. The hand truck as recited in claim 7 wherein the first and second wheels and the first and second legs are spaced apart by a distance that allows the pail suspended from the boom to swing freely between the first and second legs.

12. The hand truck as recited in claim 7 wherein the boom is a to the frame by a hinge.

13. The hand truck as recited in claim 7 wherein the receiver for engaging the handle of a pail comprises a hook.

14. The hand truck as recited in claim 7 wherein the receiver for engaging the handle of a pail comprises a plate bend into a V-shape.

15. The hand truck as recited in claim 7 further comprising a foot attached to the frame for supporting the frame in a stationary state of the hand truck.
